(19) United States
(12) Patent Application Publication
(10) Pub. No.: US 2006/0284797 A1
(43) Pub. Date: Dec. 21, 2006

(54) Plasma display panel (PDP)

(76) Inventors: Seung-Beom Seo, Suwon-si (KR); Sung-Yong Lee, Suwon-si (KR)

Correspondence Address: Robert E. Bushnell, Suite 300, 1522 K Street, N.W., Washington, DC, 20005, US

(21) Appl. No.: 11/508,226

(22) Filed: Aug. 23, 2006

Related U.S. Application Data
(63) Continuation-in-part of application No. 11/131,415, filed on May 18, 2005.

(30) Foreign Application Priority Data
May 21, 2004 (KR) 10-2004-0036395

(51) Int. Cl. G09G 3/28

(52) U.S. Cl. 345/63

(57) ABSTRACT

A Plasma Display Panel (PDP) includes: a front substrate; a rear substrate arranged parallel to the front substrate; barrier ribs arranged between the front substrate and the rear substrate and adapted to demarcate light-emitting cells in a lattice pattern; upper electrodes and lower electrodes embedded in the barrier ribs around the light-emitting cells and extending in an arrangement direction of the light-emitting cells arranged in the lattice pattern; and address electrodes embedded in the barrier ribs around the light-emitting cells and arranged between the upper electrodes and the lower electrodes; wherein the PDP is driven by a driving signal in which one frame is divided into a plurality of sub-fields according to brightness weights, each sub-field including an address period and a sustain-discharge period; and during the address period, a scanning signal is supplied to one of the upper electrodes and the lower electrodes, and an address signal is supplied to the address electrodes, to select light-emitting cells to be displayed; and during the sustain-discharge period, a sustain pulse is supplied to one of the electrodes used for selecting the light-emitting cells in the address period or to the upper electrodes and the lower electrodes.

### CROSS-REFERENCE TO RELATED PATENT APPLICATIONS

This application makes reference to, incorporates herein, and claims all benefits accruing under 35 U.S.C. § 119 from an application for PLASMA DISPLAY PANEL earlier filed in the Korean Intellectual Property Office on May 21, 2004 and there duly assigned Serial No. 10-2004-0036395. Furthermore, this application is a Continuation-in-Part of Applicants patent application Ser. No. 11/131,415 filed in the U.S. Patent & Trademark Office on May 18, 2005, and assigned to the assignee of the present invention. All benefits accruing under 35 U.S.C. §120 from the parent application are also hereby claimed.

### BACKGROUND OF THE INVENTION

1. Field of the Invention

The present invention relates to a panel driving method of displaying images by supplying a sustain pulse to an electrode structure forming display cells, such as a Plasma Display Panel (PDP).

2. Description of the Related Art

In the structure of a 3-electrode surface discharge PDP, address electrode lines A1, A2, . . . , Am, dielectric layers, Y electrode lines Y1, . . . , Yn, X electrode lines X1, . . . , Xn, phosphor layers, and barrier ribs, and a MgO layer serving as a protection layer are provided between front and rear glass substrates of the 3-electrode surface discharge PDP.

The address electrode lines A1, A2, . . . , Am are formed with a predetermined pattern on the rear glass substrate. The lower dielectric layer covers the address electrode lines A1, A2, . . . , Am. The barrier ribs are formed in a direction parallel to the address electrode lines A1, A2, . . . , Am on the lower dielectric layer. The barrier ribs demarcate discharge areas of respective display cells, thus preventing optical interference between the respective display cells. The phosphor layers are formed between the barrier ribs.

The X electrode lines X1, . . . , Xn and the Y electrode lines Y1, . . . , Yn are formed with a predetermine pattern on the rear surface of the front glass substrate to orthogonally intersect the address electrode lines A1, A2, . . . , Am. Each intersection forms a corresponding display cell. Each of the X electrode lines X1, X2, . . . , Xn can be a combination of a transparent electrode Xna formed of transparent conductive material such as Indium Tin Oxide (ITO) and a metal electrode Xnb for increasing conductivity. Each of the Y electrode lines Y1, Y2, . . . , Yn can be also a combination of a transparent electrode Yna formed of transparent conductive material, such as ITO, and a metal electrode Ynb for increasing conductivity. The upper dielectric layer is supplied to cover all the surfaces of the X electrode lines X1, X2, . . . , Xn and the Y electrode lines Y1, Y2, . . . , Yn. The protection layer 104 for protecting the panel 1 from any strong electric field, for example, a MgO layer, is supplied to cover the entire surface of the upper dielectric layer. A discharge space is filled with gas to generate a plasma and then sealed.

According to a driving method which is widely supplied to such a PDP, initialization, addressing, and display-sustain operations are sequentially effected in a unit sub-field. In the initialization operation, charges in display cells to be driven are uniformly distributed. In the addressing operation, the states of charges in light-emitting cells to be selected and the states of charges in light-emitting cells not to be selected are set. In the display-sustain operation, a sustain-discharge is effected on selected light-emitting cells. A plasma is generated by the plasma forming gas in the light-emitting cells on which the sustain-discharge is effected and the phosphor layers of the light-emitting cells are excited by ultraviolet radiation caused by the plasma, thus emitting light.

A driving apparatus to drive such a PDP includes an image processor, a logic controller, an address driver, an X driver, and a Y driver. The image processor converts an external image signal into a digital signal, and generates an internal image signal, for example, R/G/B image data, a clock signal, or horizontal and vertical synchronization signals, each having 8 bits. The logic controller generates driving control signals SA, SY, and SX in response to the internal image signal received from the image processor. The address driver processes the driving control signal SA (also, referred to as an ‘address signal’) among the driving control signals SA, SY, and SX received from the logic controller to generate a display data signal, and supplies the generated display data signal to the address electrode lines A1, . . . , Am. The X driver processes the X driving control signal SX among the driving control signals SA, SY, and SX received from the controller, and supplies the processed result to the X electrode lines X1, . . . , Xn. The Y driver processes the Y driving control signal SY among the driving control signals SA, SY, and SX received from the controller and supplies the processed result to the Y electrode lines Y1, . . . , Yn.

U.S. Pat. No. 5,541,618 discloses an address-display separation driving method which is widely used as a driving method of driving the PDP with the structure described above.

In an address-display separation driving method to drive the Y electrode lines of the PDP above, a unit frame can be divided into a predetermined number of sub-fields, for example, 8 sub-fields SF1, . . . , SF8, in order to implement a time division gray-scale display. Also, the respective sub-fields SF1, . . . , SF8 are respectively divided into reset periods, address periods A1, . . . , A8, and sustain-discharge periods S1, . . . , S8.

During the respective address periods A1, . . . , A8, a display data signal is supplied to the address electrode lines A1, A2, . . . , Am and simultaneously corresponding scanning pulses are sequentially supplied to the respective Y electrode lines Y1, . . . , Yn.

During the respective sustain-discharge periods S1, . . . , S8, a display discharge pulse is alternately supplied to the Y electrode lines Y1, . . . , Yn and X electrode lines X1, . . . , Xn so that display-discharge occurs in light-emitting cells in which wall charges have been formed during the address periods A1, . . . , A8.

The brightness of a PDP is proportional to the number of sustain discharge pulses supplied during sustain discharge periods S1, . . . , S8 in a unit frame. If a frame forming one image is displayed by 8 sub-fields in 256 gray-scales, different numbers (1, 2, 4, 8, 16, 32, 64, and 128) of sustain pulses can be sequentially assigned to the respective sub-fields. In order to obtain the brightness of a 133 gray-scale level, cells must be addressed and sustain-discharged during the periods of a first sub-field (SF1), a third sub-field (SF3), and an eighth sub-field (SF8).

The number of sustain-discharges (sustain-discharge pulses) assigned to each sub-field depends on a weight of the sub-field based on Automatic Power Control (APC). Alternately, the number of sustain-discharges assigned to each sub-field can be variously set considering gamma characteristics or panel characteristics. For example, it is possible to decrease a gray-scale level assigned to a fourth sub-field (SF4) from 8 to 6 and increase a gray-scale level assigned to a sixth sub-field (SF6) from 32 to 34. Also, the number of sub-fields forming one frame can also be variously changed according to a design rule.

An exemplary driving signal to drive the PDP above include a driving signal supplied to address electrodes A1 through An, common electrodes X1 through Xn, and scanning electrodes Y1 through Yn during a sub-field SFn according to an ADS driving method of an AC PDP. The sub-field SFₙ includes a reset period PR, an address period PA, and a sustain-discharge period PS.

During the reset period PR, a reset pulse is supplied to all groups of scanning lines so that a write-discharge is compulsorily effected, thereby initializing the states of wall charges in all of the cells. The reset period PR is effected over the whole screen before the address period PA, so that the wall charges in all of the cells can be uniformly distributed. That is, the states of wall charges in cells initialized during the reset period PR are similar. After the reset period PR has been effected, the address period PA is effected. During the address period PA, a bias voltage Vₑ is supplied to the common electrodes X1 through Xn, a scanning pulse is supplied to scanning electrodes Y1 through Yn, and a display data signal is supplied to address electrodes A1 through Am, so to select cells to be displayed. After the address period PA has been effected, a sustain pulse VS is alternately supplied to the common electrodes X through Xn and the scanning electrodes Y1 through Yn so that a sustain-discharge period PS is effected. During the sustain-discharge period PS, a low-level voltage V_{G} is supplied to the address electrodes A1 through Am.

In the structure of the 3-electrode surface discharge PDP as described above, the X electrodes X1 through Xn, the Y electrodes Y1 through Yn, the dielectric layers, and the protection layer, such as a MgO layer, are provided below the front substrate which visible light generated from phosphor layers reaches. Therefore, the front substrate passes visible light there through with a low transmittance of about 60%.

Also, in such a 3-electrode surface discharge PDP, since a discharge generated in the upper portion of each light-emitting cell is spread to the center portion of the light-emitting cell, the light-emitting efficiency is low.

Also, the 3-electrode surface discharge PDP has a drawback in that an electric field formed by charged particles in discharge gas causes ion-sputtering of the phosphors when the panel is used for a long time, which leaves a permanent afterimage.

Also, in the 3-electrode surface discharge PDP, by supplying sustain pulses to scanning electrodes (Y) and common electrodes (X), a sustain-discharge is effected. Since the intensity of light generated by a unit sustain pulse is constant, representation in low gray-scale is relatively low. To compensate for this problem, a method such as error diffusion has been developed. However, it is difficult to greatly improve representation in low gray-scale through such error diffusion.

### SUMMARY OF THE INVENTION

The present invention provides a PDP with an improved structure, capable of achieving improvement in opening ratio, improvement in transmittance, improvement in light-emitting efficiency, improvement in a response speed, allowance of low-voltage driving, enhancement of representation in low gray-scale, and so on.

According to one aspect of the present invention, a Plasma Display Panel (PDP) is provided comprising: a front substrate; a rear substrate arranged parallel to the front substrate; barrier ribs arranged between the front substrate and the rear substrate and adapted to demarcate light-emitting cells in a lattice pattern; upper electrodes and lower electrodes embedded in the barrier ribs around the light-emitting cells and extending in an arrangement direction of the light-emitting cells arranged in the lattice pattern; and address electrodes embedded in the barrier ribs around the light-emitting cells and arranged between the upper electrodes and the lower electrodes; wherein the PDP is driven by a driving signal in which one frame is divided into a plurality of sub-fields according to brightness weights, each sub-field including an address period and a sustain-discharge period; and during the address period, a scanning signal is supplied to one of the upper electrodes and the lower electrodes, and an address signal is supplied to the address electrodes, to select light-emitting cells to be displayed; and during the sustain-discharge period, a sustain pulse is supplied to one of the electrodes used for selecting the light-emitting cells in the address period or to the upper electrodes and the lower electrodes.

The plurality of sub-fields preferably comprise a low gray-scale group and a high gray-scale group; and in the low gray-scale group, a sustain pulse is preferably supplied to one of the electrodes used for selecting the light-emitting cells in the address period to effect the sustain-discharge period; and in the high gray-scale group, a sustain pulse is preferably supplied to one of the upper electrodes and the lower electrodes in the light-emitting cells selected in the address period to effect the sustain-discharge period.

In the low gray-scale group, the other of the electrodes used for selecting the light-emitting cells in the address period to effect the sustain-discharge period is floated; and in the high gray-scale group, the other of the upper electrodes and the lower electrodes in the light-emitting cells selected in the address period to effect the sustain-discharge period is floated.

The sustain pulse alternately has a positive polarity voltage and a negative polarity voltage.

The upper electrodes and the lower electrodes preferably extend in a direction with a ladder form surrounding the light-emitting cell, and the address electrodes preferably have a ladder form surrounding the light-emitting cells and extend in a direction orthogonally intersecting the extended direction of the upper electrodes and the lower electrodes.

According to another aspect of the present invention, a Plasma Display Panel (PDP) is provided comprising: a front substrate; a rear substrate arranged parallel to the front substrate; barrier ribs arranged between the front substrate and the rear substrate and adapted to demarcate light-emitting cells in a lattice pattern; upper electrodes and lower electrodes embedded in the barrier ribs around the light-emitting cells and extending in an arrangement direction of the light-emitting cells arranged in the lattice pattern; and address electrodes embedded in the barrier ribs around the light-emitting cells and arranged between the lower electrodes and the rear substrate; wherein the PDP is driven by a driving signal in which one frame is divided into a plurality of sub-fields according to brightness weights, each sub-field including an address period and a sustain-discharge period; and during the address period, a scanning signal is supplied to the upper electrodes and an address signal is supplied to the address electrodes to select light-emitting cells to be displayed; and during the sustain-discharge period, a sustain pulse is supplied to one of the upper electrodes and the lower electrodes or to the upper electrodes and the address electrodes, in the light-emitting cells selected in the address period.

The plurality of sub-fields are preferably classified into a low gray-scale group and a high gray-scale group; and in the low gray-scale group, a sustain pulse is preferably supplied to one of the upper electrodes and the lower electrodes in the light-emitting cells selected in the address period to effect the sustain-discharge period; and in the high gray-scale group, a sustain pulse is preferably supplied to one of the upper electrodes and the address electrodes in the light-emitting cells selected in the address period to effect the sustain-discharge period.

In the low gray-scale group, the other of the upper electrodes and the lower electrodes in the light-emitting cells selected in the address period to effect the sustain-discharge period is floated; and in the high gray-scale group, the other of the upper electrodes and the address electrodes in the light-emitting cells selected in the address period to effect the sustain-discharge period is floated.

The sustain pulse alternately has a positive polarity voltage and a negative polarity voltage.

The upper electrodes and the lower electrodes preferably extend in a direction with a ladder form surrounding the light-emitting cells, and the address electrodes preferably have a ladder form surrounding the light-emitting cells and extend in a direction orthogonally intersecting the extended direction of the upper electrodes and the lower electrodes.

According to yet another aspect of the present invention, a Plasma Display Panel (PDP) is provided comprising: a front substrate; a rear substrate arranged parallel to the front substrate; barrier ribs arranged between the front substrate and the rear substrate and adapted to demarcate light-emitting cells in a lattice pattern; upper electrodes and lower electrodes embedded in the barrier ribs around the light-emitting cells and extending in an arrangement direction of the light-emitting cells arranged in the lattice pattern; and address electrodes embedded in the barrier ribs around the light-emitting cells and arranged between the upper electrodes and the front substrate; wherein the PDP is driven by a driving signal in which one frame is divided into a plurality of sub-fields according to brightness weights, each sub-field including an address period and a sustain-discharge period; and during the address period, a scanning signal is supplied to the lower electrodes and an address signal is supplied to the address electrodes to select light-emitting cells to be displayed; and during the sustain-discharge period, a sustain pulse is supplied to one of the upper electrodes and the lower electrodes or to the lower electrodes and the address electrodes.

The plurality of sub-fields are preferably classified into a low gray-scale group and a high gray-scale group; and in the low gray-scale group, a sustain pulse is preferably supplied to one of the upper electrodes and the lower electrodes in the light-emitting cells selected in the address period to effect the sustain-discharge period; and in the high gray-scale group, a sustain pulse is preferably supplied to one of the address electrodes and the lower electrodes in the light-emitting cells selected in the address period to effect the sustain-discharge period.

In the low gray-scale group, the other f the upper electrodes and the lower electrodes in the light-emitting cells selected in the address period to effect the sustain-discharge period is floated; and in the high gray-scale group, the other of the address electrodes and the lower electrodes in the light-emitting cells selected in the address period to effect the sustain-discharge period is floated.

The sustain pulse alternately has a positive polarity voltage and a negative polarity voltage.

The upper electrodes and the lower electrodes preferably are extended in a direction with a ladder form surrounding the light-emitting cells; and the address electrodes preferably have a ladder form surrounding the light-emitting cells and extend in a direction orthogonally intersecting the extended direction of the upper electrodes and the lower electrodes.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIGS. 1 and 2 are views of the structure of a 3-electrode surface discharge PDP;

FIG. 3 is a block diagram of a driving apparatus to drive the PDP of FIG. 1;

FIG. 4 is a view for explaining an address-display separation driving method of driving Y electrode lines of the PDP of FIG. 1;

FIG. 5 is a timing diagram of an exemplary driving signal for driving the PDP of FIG. 1;

FIG. 6 is a perspective view of a PDP according to an embodiment of the present invention;

FIG. 7 is a perspective view of an electrode structure of the PDP of FIG. 6, according to an embodiment of the present invention;

FIG. 8 is a perspective view of a PDP according to another embodiment of the present invention;

FIG. 9 is a perspective view of an electrode structure of the PDP of FIG. 8, according to another embodiment of the present invention;

FIG. 10 is a perspective view of a PDP according to another embodiment of the present invention;

FIG. 11 is a perspective view of an electrode structure of the PDP of FIG. 10, according to another embodiment of the present invention;

FIGS. 12A and 12B are views for explaining sustain-discharge effected in the PDP structure of FIG. 6, according to an embodiment of the present invention;

FIG. 13 is a timing diagram of a sustain-discharge driving signal supplied to the PDP according to the present invention, according to an embodiment of the present invention;

FIG. 14 is a timing diagram of a sustain-discharge driving signal supplied to the PDP according to the present invention, according to another embodiment of the present invention;

FIGS. 15A and 15B are views of the structure of a PDP where lower electrodes of FIG. 6 are used as scanning electrodes and upper electrodes of FIG. 6 are used as common electrodes, according to an embodiment of the present invention;

FIGS. 16A and 16B are views of the structure of a PDP where the upper electrodes of FIG. 6 are used as scanning electrodes and the lower electrodes of FIG. 6 are used as common electrodes, according to another embodiment of the present invention;

FIGS. 17A and 17B are views of the structure of a PDP where upper electrodes of FIG. 8 are used as scanning electrodes, lower electrodes of FIG. 8 are used as common electrodes, and address electrodes are inserted between the lower electrodes and the rear substrate, according to another embodiment of the present invention;

FIGS. 18A and 18B are views of the structure of a PDP where upper electrodes of FIG. 10 are used as common electrodes, lower electrodes of FIG. 10 are used as scanning electrodes, and address electrodes are inserted between the upper electrodes and the front substrate, according to another embodiment of the present invention.

FIG. 19 is a timing diagram of a sustain-discharge driving signal supplied to the PDP according to another embodiment of the present invention;

FIG. 20 is a timing diagram of a sustain-discharge driving signal supplied to the PDP according to another embodiment of the present invention;

FIG. 21 is a timing diagram of a sustain-discharge driving signal supplied to the PDP according to another embodiment of the present invention; and

FIG. 22 is a timing diagram of a sustain-discharge driving signal supplied to the PDP according to another embodiment of the present invention;

### DETAILED DESCRIPTION OF THE INVENTION

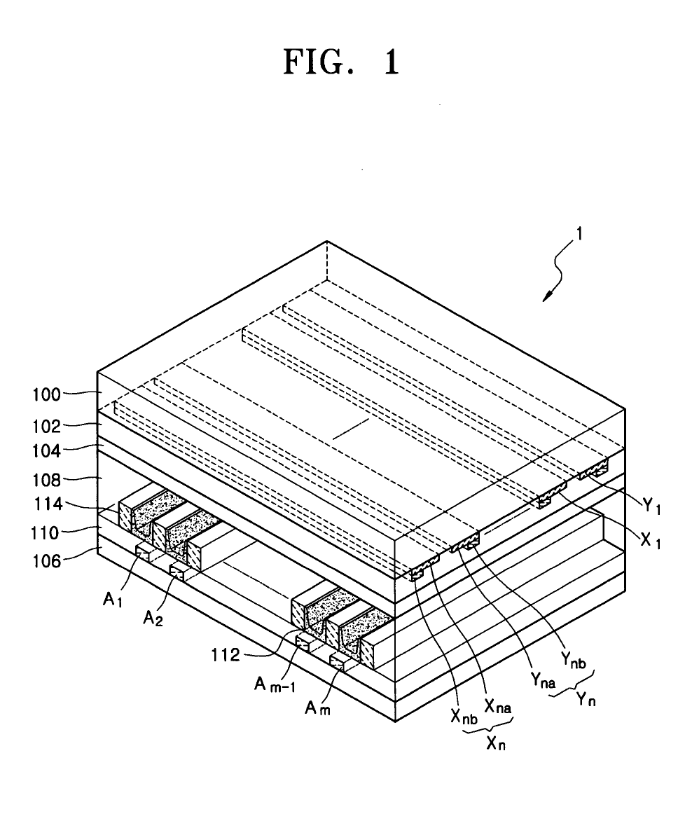

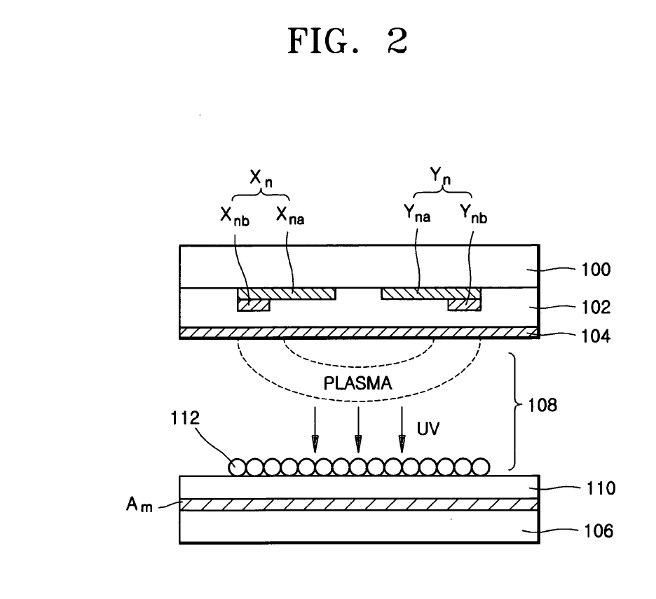

FIGS. 1 and 2 are views of the structure of a 3-electrode surface discharge PDP.

Referring to FIGS. 1 and 2, address electrode lines A1, A2, . . . , Am, dielectric layers 102 and 110, Y electrode lines Y1, . . . , Yn, X electrode lines X1, . . . , Xn, phosphor layers 112 (112 for each), and barrier ribs 114 (114 for each), and a MgO layer 104 serving as a protection layer are provided between front and rear glass substrates 100 and 106 of the 3-electrode surface discharge PDP 1.

The address electrode lines A1, A2, . . . , Am are formed with a predetermined pattern on the rear glass substrate 106. The lower dielectric layer 110 covers the address electrode lines A1, A2. . . . , Am. The barrier ribs 114 are formed in a direction parallel to the address electrode lines A1, A2, . . . , Am on the lower dielectric layer 110. The barrier ribs 114 demarcate discharge areas of respective display cells, thus preventing optical interference between the respective display cells. The phosphor layers 112 are formed between the barrier ribs 114.

The X electrode lines X1, . . . , Xn and the Y electrode lines Y1, . . . , Yn are formed with a predetermine pattern on the rear surface of the front glass substrate 100 to orthogonally intersect the address electrode lines A1, A2, . . . , Am. Each intersection forms a corresponding display cell. Each of the X electrode lines X1, X2, . . . , Xn can be a combination of a transparent electrode Xna formed of transparent conductive material such as Indium Tin Oxide (ITO) and a metal electrode Xnb for increasing conductivity. Each of the Y electrode lines Y1, Y2, . . . , Yn can be also a combination of a transparent electrode Yna formed of transparent conductive material, such as ITO, and a metal electrode Ynb for increasing conductivity. The upper dielectric layer 102 is supplied to cover all the surfaces of the X electrode lines X1, X2, . . . , Xn and the Y electrode lines Y1, Y2, . . . , Yn. The protection layer 104 for protecting the panel 1 from any strong electric field, for example, a MgO layer, is supplied to cover the entire surface of the upper dielectric layer 102. A discharge space 108 is filled with gas to generate a plasma and then sealed.

According to a driving method which is widely supplied to such a PDP, initialization, addressing, and display-sustain operations are sequentially effected in a unit sub-field. In the initialization operation, charges in display cells to be driven are uniformly distributed. In the addressing operation, the states of charges in light-emitting cells to be selected and the states of charges in light-emitting cells not to be selected are set. In the display-sustain operation, a sustain-discharge is effected on selected light-emitting cells. A plasma is generated by the plasma forming gas in the light-emitting cells on which the sustain-discharge is effected and the phosphor layers 112 of the light-emitting cells are excited by ultraviolet radiation caused by the plasma, thus emitting light.

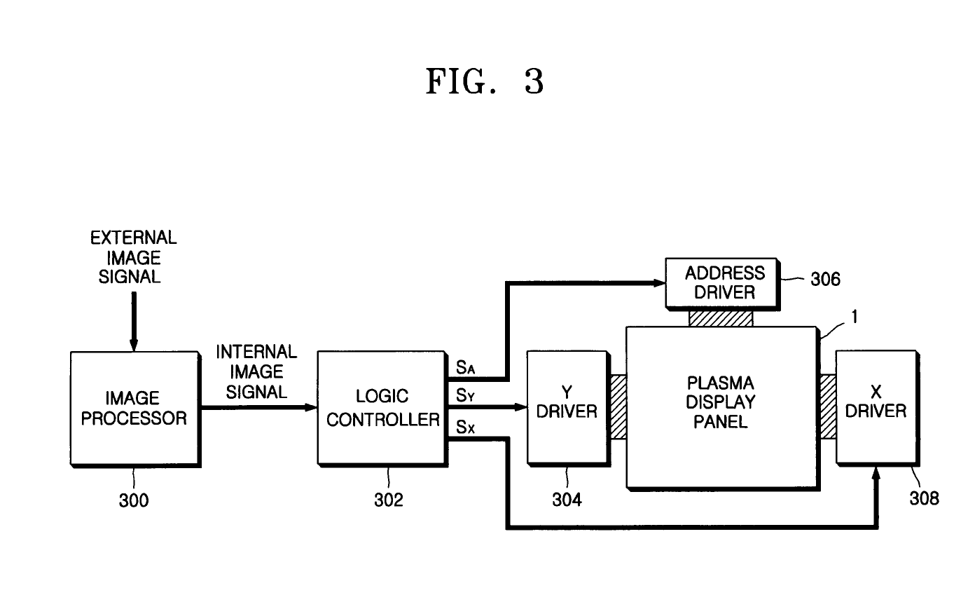

FIG. 3 is a block diagram of a driving apparatus to drive the PDP 1 of FIG. 1.

Referring to FIG. 3, the driving apparatus includes an image processor 300, a logic controller 302, an address driver 306, an X driver 308, and a Y driver 304. The image processor 300 converts an external image signal into a digital signal, and generates an internal image signal, for example, R/G/B image data, a clock signal, or horizontal and vertical synchronization signals, each having 8 bits. The logic controller 302 generates driving control signals SA, SY, and SX in response to the internal image signal received from the image processor 300. The address driver 306 processes the address driving control signal SA (also, referred to as an ‘address signal’) among the driving control signals SA, SY, and SX received from the logic controller 302 to generate a display data signal, and supplies the generated display data signal to the address electrode lines A1, . . . , Am. The X driver 308 processes the X driving control signal SX among the driving control signals SA, SY, and SX received from the controller 302, and supplies the processed result to the X electrode lines X1, . . . , Xn. The Y driver 304 processes the Y driving control signal SY among the driving control signals SA, SY, and SX received from the controller 302 and supplies the processed result to the Y electrode lines Y1, . . . , Yn.

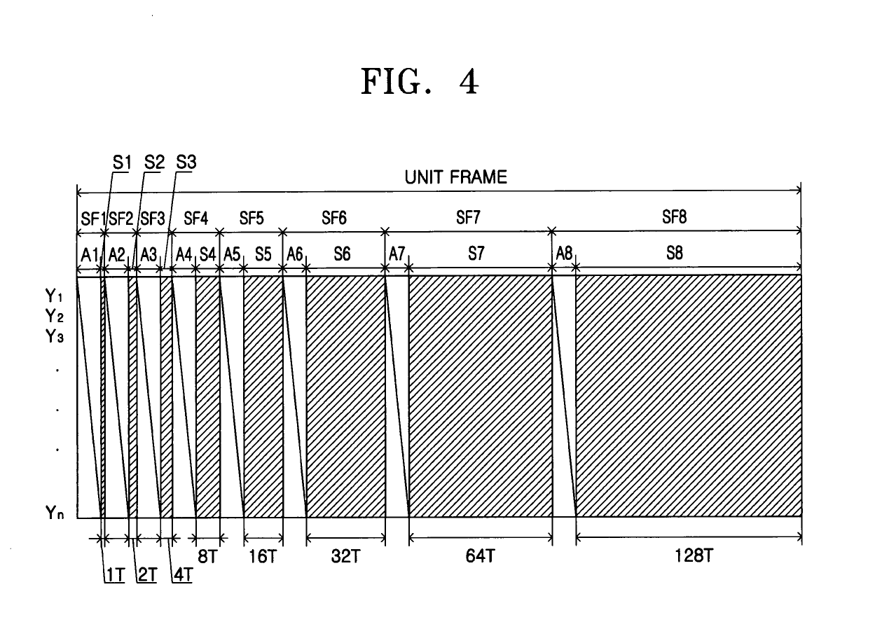

FIG. 4 is a view for explaining an address-display separation driving method to drive the Y electrode lines of the PDP 1 of FIG. 1.

Referring to FIG. 4, a unit frame can be divided into a predetermined number of sub-fields, for example, 8 sub-fields SF1, . . . , SF8, in order to implement a time division gray-scale display. Also, the respective sub-fields SF1, . . . , SF8 are respectively divided into reset periods (not shown), address periods A1, . . . , A8, and sustain-discharge periods S1, . . . , S8.

During the respective address periods A1, . . . , A8, a display data signal is supplied to the address electrode lines A1, A2, . . . , Am and simultaneously corresponding scanning pulses are sequentially supplied to the respective Y electrode lines Y1, . . . , Yn.

During the respective sustain-discharge periods S1, . . . , S8, a display discharge pulse is alternately supplied to the Y electrode lines Y1, . . . , Yn and X electrode lines X1, . . . , Xn so that display-discharge occurs in light-emitting cells in which wall charges have been formed during the address periods A1, . . . , A8.

The brightness of a PDP is proportional to the number of sustain discharge pulses supplied during sustain discharge periods S1, . . . , S8 in a unit frame. If a frame forming one image is displayed by 8 sub-fields in 256 gray-scales, different numbers (1, 2, 4, 8, 16, 32, 64, and 128) of sustain pulses can be sequentially assigned to the respective sub-fields. In order to obtain the brightness of a 133 gray-scale level, cells must be addressed and sustain-discharged during the periods of a first sub-field (SF1), a third sub-field (SF3), and an eighth sub-field (SF8).

The number of sustain-discharges (sustain-discharge pulses) assigned to each sub-field depends on a weight of the sub-field based on Automatic Power Control (APC). Alternately, the number of sustain-discharges assigned to each sub-field can be variously set considering gamma characteristics or panel characteristics. For example, it is possible to decrease a gray-scale level assigned to a fourth sub-field (SF4) from 8 to 6 and increase a gray-scale level assigned to a sixth sub-field (SF6) from 32 to 34. Also, the number of sub-fields forming one frame can also be variously changed according to a design rule.

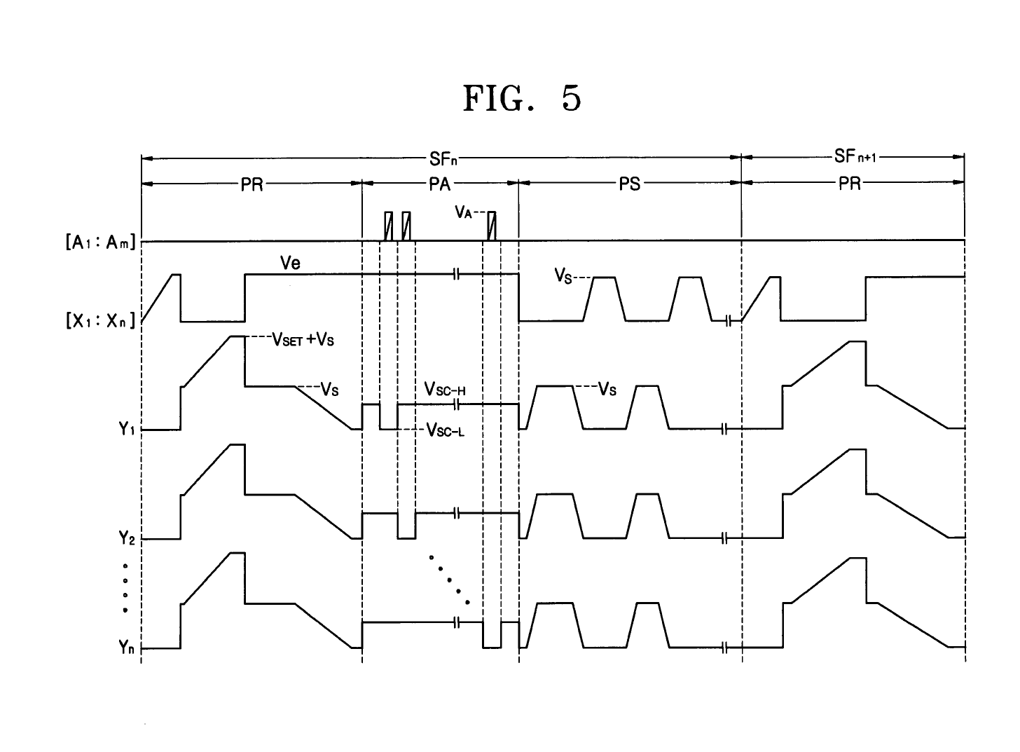

FIG. 5 is a timing diagram of an exemplary driving signal to drive the PDP 1 of FIG. 1. FIG. 5 shows a driving signal supplied to address electrodes A1 through An, common electrodes X1 through Xn, and scanning electrodes Y1 through Yn during a sub-field SFₙ according to an ADS driving method of an AC PDP. Referring to FIG. 5, the sub-field SFₙ includes a reset period PR, an address period PA, and a sustain-discharge period PS.

During the reset period PR, a reset pulse is supplied to all groups of scanning lines so that a write-discharge is compulsorily effected, thereby initializing the states of wall charges in all of the cells. The reset period PR is effected over the whole screen before the address period PA, so that the wall charges in all of the cells can be uniformly distributed. That is, the states of wall charges in cells initialized during the reset period PR are similar. After the reset period PR has been effected, the address period PA is effected. During the address period PA, a bias voltage Vₑ is supplied to the common electrodes X1 through Xn, a scanning pulse is supplied to scanning electrodes Y1 through Yn, and a display data signal is supplied to address electrodes A1 through Am, so to select cells to be displayed. After the address period PA has been effected, a sustain pulse VS is alternately supplied to the common electrodes X through Xn and the scanning electrodes Y1 through Yn so that a sustain-discharge period PS is effected. During the sustain-discharge period PS, a low-level voltage V_{G} is supplied to the address electrodes A1 through Am.

In the structure of the 3-electrode surface discharge PDP as described above, the X electrodes X1 through Xn, the Y electrodes Y1 through Yn, the dielectric layers 102, and the protection layer 104, such as a MgO layer, are provided below the front substrate 100 which visible light generated from phosphor layers 112 reaches. Therefore, the front substrate 100 passes visible light there through with a low transmittance of about 60%.

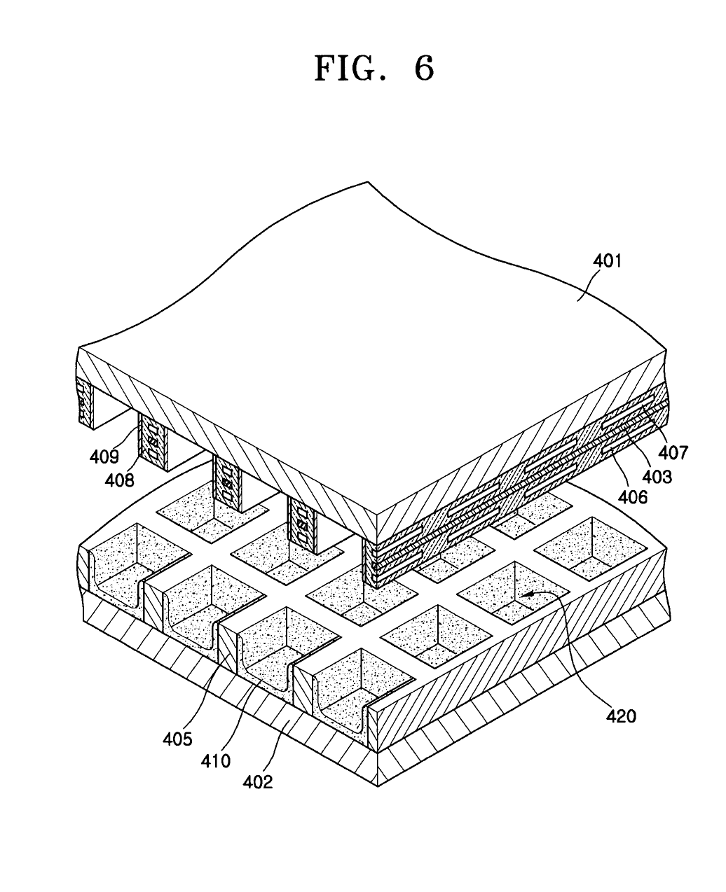

Also, in such a 3-electrode surface discharge PDP, since a discharge generated in the upper portion of each light-emitting cell (420 of FIG. 6) is spread to the center portion of the light-emitting cell 420, the light-emitting efficiency is low.

Also, the 3-electrode surface discharge PDP has a drawback in that an electric field formed by charged particles in discharge gas causes ion-sputtering of the phosphors when the panel is used for a long time, which leaves a permanent afterimage.

Also, in the 3-electrode surface discharge PDP, by supplying sustain pulses to scanning electrodes (Y) and common electrodes (X), a sustain-charge is effected. Since the intensity of light generated by a unit sustain pulse is constant, representation in low gray-scale is relatively low. To compensate for this problem, a method such as error diffusion has been developed. However, it is difficult to greatly improve representation in low gray-scale through such error diffusion.

FIG. 6 is a perspective view of a PDP according to an embodiment of the present invention.

Referring to FIG. 6, the PDP includes a front substrate 401; a rear substrate 402 separated by a predetermined distance from the front substrate 401 and parallel to the front substrate 401; barrier ribs 405 (405 for each) and 408 (408 for each) demarcating lattice-type light-emitting cells 420 (420 for each), arranged between the front substrate 401 and the rear substrate 402; and upper electrodes 407 (X) (407 for each) and lower electrodes 406 (Y) (406 for each) embedded in the barrier ribs 408 around the light-emitting cells 420. The upper electrodes 407 (X) and the lower electrodes 406 (Y) are arranged in an arrangement direction of the lattice-type light-emitting cells 420, for example, in a horizontal direction. Each phosphor layer 410 is formed to cover the lower portion of each light-emitting cell 420. Also, each light-emitting cell 420 is filled with discharge gas (not shown).

The barrier ribs 405 and 408 are divided into upper barrier ribs 408 formed on the lower surface of the front substrate 401 and lower barrier ribs 405 formed on the upper surface of the rear substrate 402, as shown in FIG. 6. Alternately, the upper barrier ribs 408 and the lower barrier ribs 405 can be integrally formed.

In a structure where the upper barrier ribs 408 are separated from the lower barrier ribs 405, the upper electrodes 407 (X) and the lower electrodes 406 (Y) are embedded in the upper barrier ribs 408 around the light-emitting cells 420, and the phosphor layers 410 are supplied in the lower portions of the light-emitting cells 420 and on the lateral portions of the lower barrier ribs 405.

The address electrodes 403 are arranged between the upper electrodes 407 and the lower electrodes 406, and are embedded in the barrier ribs 408 around the light-emitting cells 420, and extend in a direction orthogonally intersecting the upper electrodes 407 and the lower electrodes 406. Each intersection forms a corresponding display cell 420.

In a structure where the upper barrier ribs 408 are separated from the lower barrier ribs 405, a dielectric forming the upper barrier ribs 408 can be made of material, capable of preventing the direct conduction between the electrodes 406, 403, and 407 when sustain-discharging, preventing the damages of the electrodes 406, 403, and 407 due to the direct collision of charged particles with the electrodes 406, 403, and 407, and attracting the charged particles to be accumulated as wall charges. Such a dielectric material includes PbO, B₂O₃, SiO₂, and the like.

Both the lateral portions of each upper barrier rib 408 can be covered with a protection film, such as a MgO film, 409. The MgO film 409 acts to prevent the charged particles from colliding with the upper barrier ribs 408 and thus damaging the upper barrier ribs 408, and to accelerate discharging of secondary electrons when discharging.

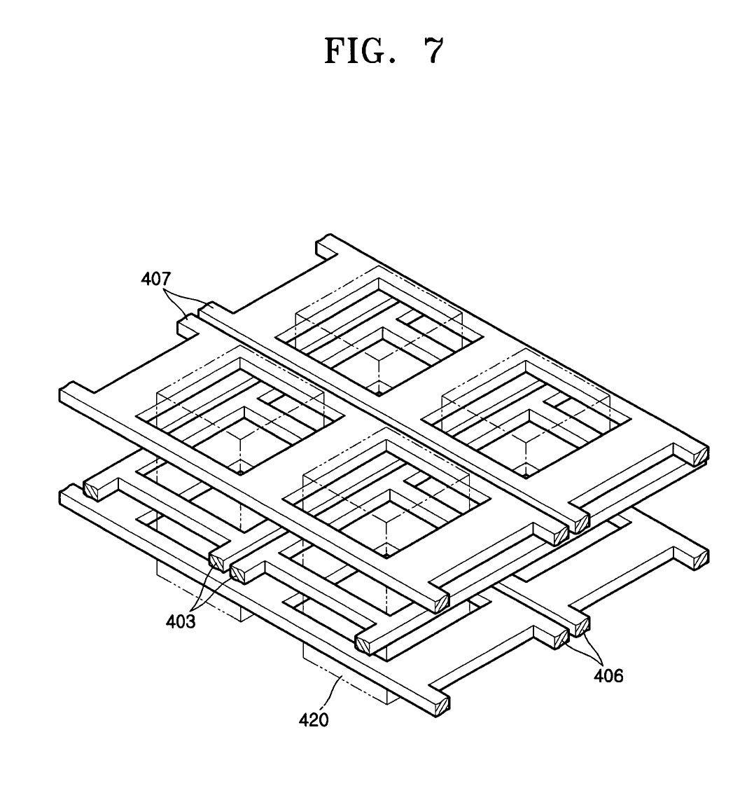

FIG. 7 is a perspective view of an electrode structure of the PDP of FIG. 6, according to an embodiment of the present invention;

Referring to FIG. 7, the upper electrodes 407 and the lower electrodes 406 are arranged in a ladder form surrounding lattice-type light-emitting cells 420 and extend in one direction. The address electrodes 403 are also arranged with a ladder form surrounding the lattice-type light-emitting cells 420, arranged between the upper electrodes 407 and the lower electrodes 406, and extend in a direction orthogonally intersecting the extended direction of the upper electrodes 407 and the lower electrodes 406.

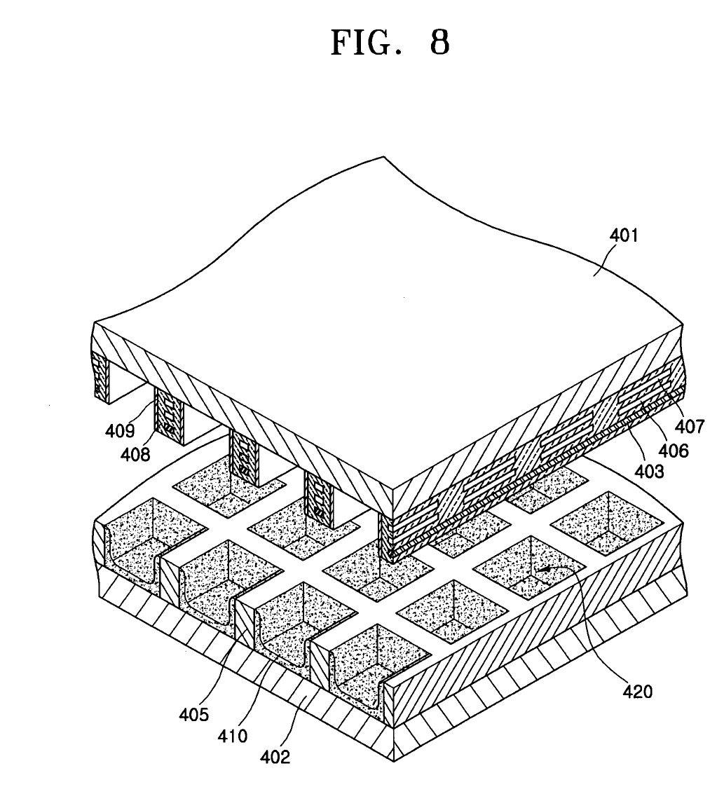

FIG. 8 is a perspective view of a PDP according to another embodiment of the present invention. The structure shown in FIG. 8 is different from that of FIG. 6, in that address electrodes 403, which extend in a direction orthogonally intersecting the extended direction of upper electrodes 407 and lower electrodes 406, are arranged between the lower electrodes 406 and a rear substrate 402.

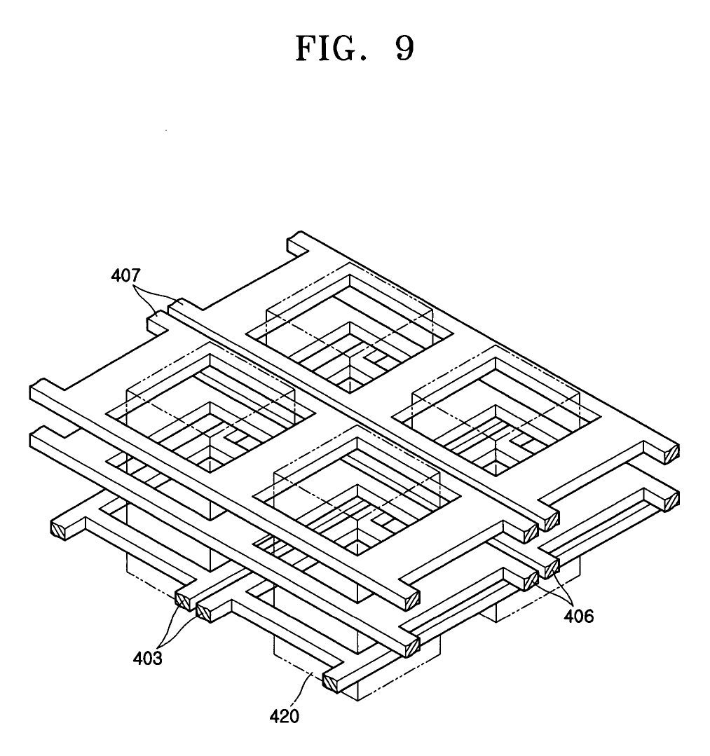

FIG. 9 is a perspective view of an electrode structure of the PDP of FIG. 8, according to another embodiment of the present invention.

Referring to FIG. 9, the upper electrodes 407 and the lower electrodes 406 are arranged in a ladder form surrounding lattice-type light-emitting cells 420 and extend in one direction. The address electrodes 403 are also arranged in a ladder form surrounding the lattice-type light-emitting cells 420, arranged between the lower electrodes 406 and a rear substrate 402, and extend in a direction orthogonally intersecting the extended direction of the upper electrodes 407 and the lower electrodes 406.

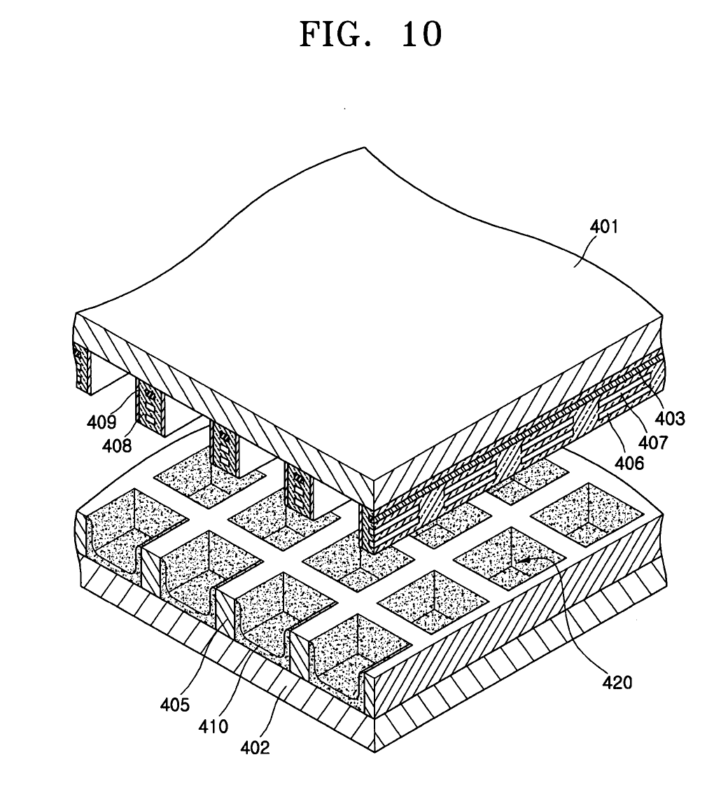

FIG. 10 is a perspective view of a PDP according to still another embodiment of the present invention. The structure shown in FIG. 10 is different from that of FIG. 6, in that address electrodes 403, which extend in a direction orthogonally intersecting the extended direction of the upper electrodes 407 and lower electrodes 406, are arranged over the upper electrodes 407 and the lower electrodes 406.

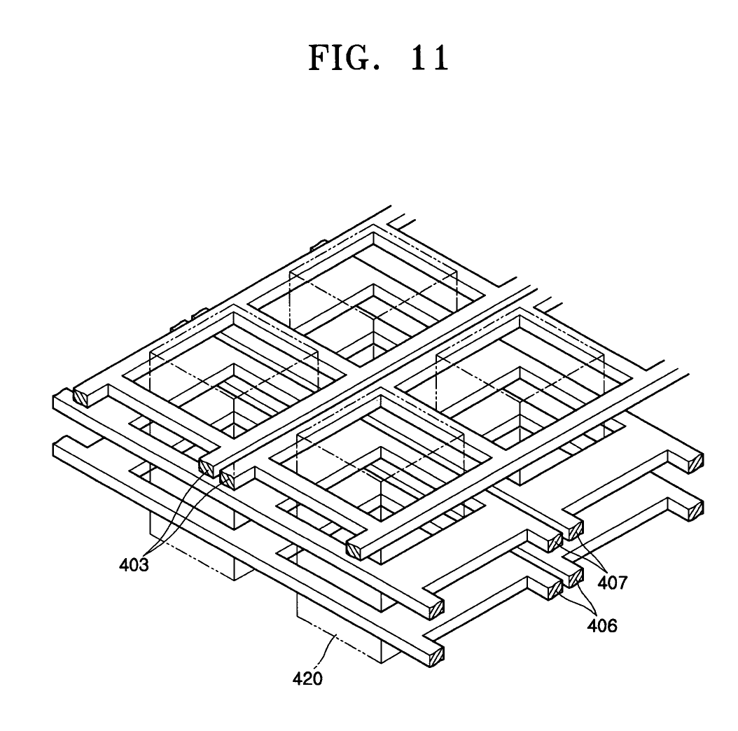

FIG. 11 is a perspective view of an electrode structure of the PDP of FIG. 10, according to yet another embodiment of the present invention.

Referring to FIG. 11, the upper electrodes 407 and the lower electrodes 406 are arranged in a ladder form surrounding the lattice-type light-emitting cells 420, and extend in one direction. The address electrodes 403 are arranged in a ladder form surrounding the lattice-type light-emitting cells 420, and arranged over the upper electrodes 407 and the lower substrates 406 in a direction orthogonally intersecting the extended direction of the upper electrodes 407 and the lower electrodes 406.

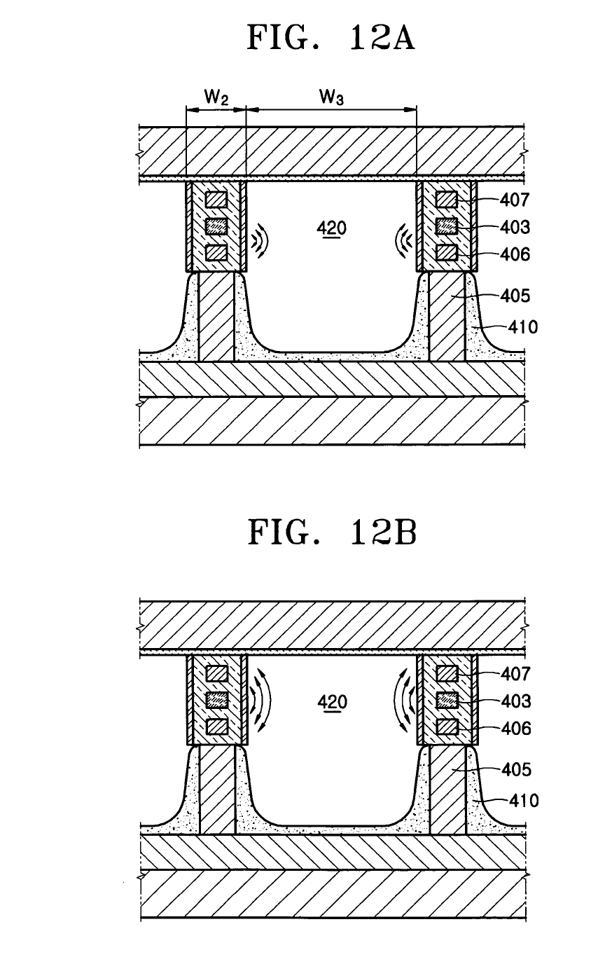

FIGS. 12A and 12B are views for explaining the sustain-discharge of the PDP structure of FIG. 6, according to an embodiment of the present invention.

In the panel structure according to the present invention, light generated by the phosphors is spread to the front substrate through all regions excluding the widths W2 of the barrier ribs, without any structural interference of electrodes. Accordingly, the aperture ratio remarkably increases compared with a conventional 3-electrode surface discharge panel structure. Also, in the panel structure according to the present invention, since no electrodes, dielectrics, protection layers, etc. exists on a transmission path of visual light to the front substrate, the transmittance can be remarkably improved.

The PDP according to the present invention is driven by a driving signal in which one frame corresponding to an input image is divided into a plurality of sub-fields according to brightness weights. Each sub-field includes an address period and a sustain-discharge period.

FIGS. 12A and 12B are views of the structure of a PDP where the lower electrodes 406 of FIG. 6 are used as scanning electrodes Y and the upper electrodes 407 of FIG. 6 are used as common electrodes X, according to an embodiment of the present invention.

First, during an address period, a scanning signal is supplied to the scanning electrodes 406 (Y) and an address signal is supplied to the address electrodes 403 (A), to select light-emitting cells to be displayed.

Then, during a sustain-discharge period, a sustain pulse is alternately supplied to the scanning electrodes 406 (Y) and the address electrodes 403 (A) in the light-emitting cells selected in the address period, as shown in FIG. 12A. Alternatively, a sustain pulse is alternately supplied to the scanning electrodes 406 (Y) and the common electrodes 407 (X), as shown in FIG. 12B, thereby effecting a sustain-discharge.

In the panel structure according to the present invention, since electrodes X, A, and Y are vertically arranged around the light-emitting cells 420, the discharge efficiency is very high compared with a conventional 3-electrode surface discharge panel structure. As the discharge progresses, an electric field formed in neighboring areas of the two electrodes is gradually and strongly confined, so that the discharge is spread across the entire area of the light-emitting cell 420.

In a conventional 3-electrode surface discharge panel structure, a discharge generated only from the upper portion of each light-emitting cell 420 is spread to the center portion of the light-emitting cell 420. However, in the panel structure according to the present invention, as shown in FIG. 6 and FIG. 8, discharge is generated in a ring form from four lateral portions around each light-emitting cell 420 and spreads to the center portion of the light-emitting cell 420. Accordingly, the spread range of the discharge greatly increases and, hence, the amount of visible light generated remarkably increases. Also, since the plasma is concentrated in the center portion of each light-emitting cell 420, space charges can be efficiently used, which allows a low driving voltage, improves light-emitting efficiency, and accelerates a discharge response speed. Also, since the plasma is concentrated in the center portion of each light-emitting cell 420 and an electric field caused by the electrodes 406 (Y) and 407 (X) is formed near the plasma, charges are concentrated on the center portion of the light-emitting cell 420, thus ultimately preventing ion-sputtering of the phosphor layers 410.

In the display panel structure according to the present invention, it is important for the discharge response speed to be very fast. This advantage is obtained because the plasma is concentrated in the center portion of each light-emitting cell 420 and only metal electrodes are used instead of transparent electrodes. Also, this advantage is obtained because electrodes are embedded in barrier ribs instead of being arranged in a transmission path of light generated from phosphors.

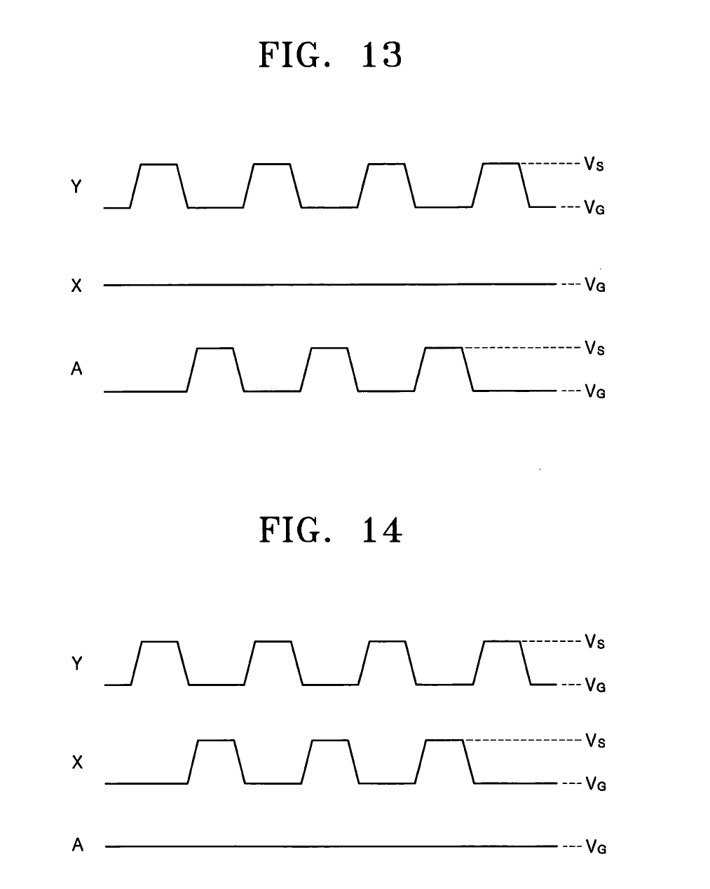

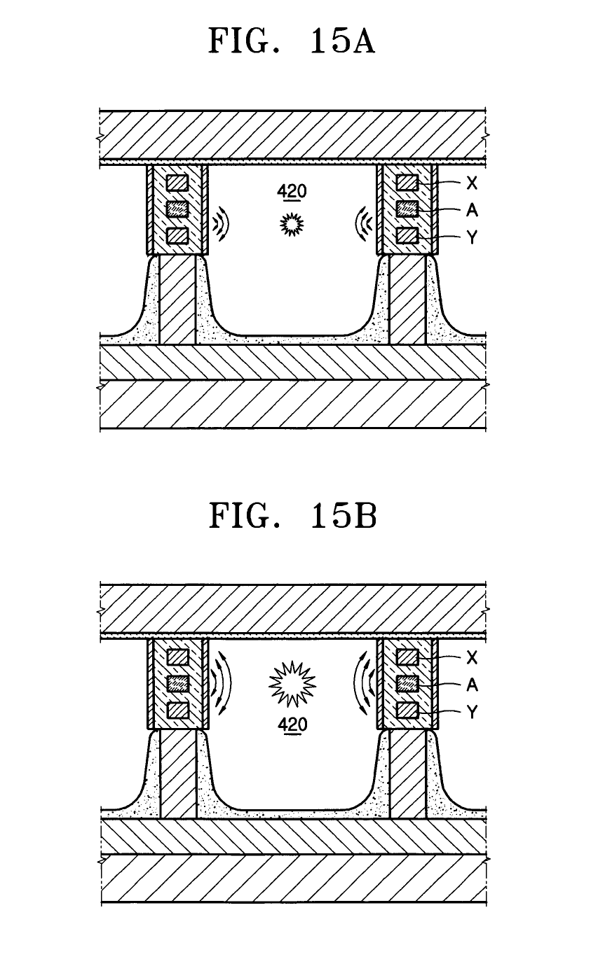

FIG. 13 is a timing diagram of a sustain-discharge driving signal supplied to the PDP according to an embodiment of the present invention, wherein the sustain-discharge driving signal is used for the sustain-discharge described above with reference to FIG. 12A. Referring to FIG. 13, when a ground voltage VG is supplied to the common electrodes (X), a sustain pulse is alternately supplied to the address electrodes (A) and the scanning electrodes (Y). Also, the driving signal shown in FIG. 13 is provided to drive the structures of FIGS. 15A, 16A, 17B, and 18B.

FIG. 14 is a timing diagram of a sustain-discharge driving signal supplied to the PDP according to another embodiment of the present invention, wherein the sustain-discharge driving signal is used for sustain-discharge described above with reference to FIG. 12B. Referring to FIG. 14, while a ground voltage VG is supplied to the address electrodes A, a sustain pulse is alternately supplied to the scanning electrodes (Y) and the common electrodes (X). Also, the driving signal shown in FIG. 14 is provided to drive the structures shown in FIGS. 15B, 16B, 17A, and 18A, as will be described later.

When driving the PDP according to the present invention, it is possible to classify a plurality of sub-fields into a low gray-scale group and a high gray-scale group and separately drive the two groups.

As discharge spaces increase, the amount of Vacuum Ultra Violet (VUV) generated increases when discharging. As the generated amount of VUV increases, the intensity of visible light increases. As a result, as discharge spaces increase, the light-emitting intensity increases. Also, as discharge spaces decrease, the light-emitting intensity decreases.

Considering this principle, in the low gray-scale group, the sustain discharge is effected using relatively narrow discharge spaces between neighboring electrodes, as shown in FIG. 12A. In the high gray-scale group, the sustain discharge is effected using relatively wide discharge spaces between distant electrodes, as shown in FIG. 12B.

As such, by using electrode pairs for the sustain-discharge of the high gray-scale group separate from those for the sustain-discharge of the low gray-scale group, it is possible to more finely represent gray-scale levels.

Various embodiments of panel driving methods that separately drive the low gray-scale group and high gray-scale group are included in FIGS. 15A and 15B.

FIGS. 15A and 15B are views of the structure of a PDP where the lower electrodes 406 of FIG. 6 are used as scanning electrodes (Y) and the upper electrodes 407 of FIG. 6 are used as common electrodes (X), according to an embodiment of the present invention.

FIG. 15A is a view for explaining a discharge effected in the low gray-scale group, wherein the sustain-discharge is effected using the address electrodes (A) and the lower scanning electrodes (Y). The driving signal of FIG. 13 is used for the sustain-discharge.

FIG. 15B is a view for explaining discharge effected in the high gray-scale group, wherein the sustain-discharge is effected using the upper common electrodes (X) and the lower scanning electrodes (Y). The driving signal of FIG. 14 is used for the sustain-discharge.

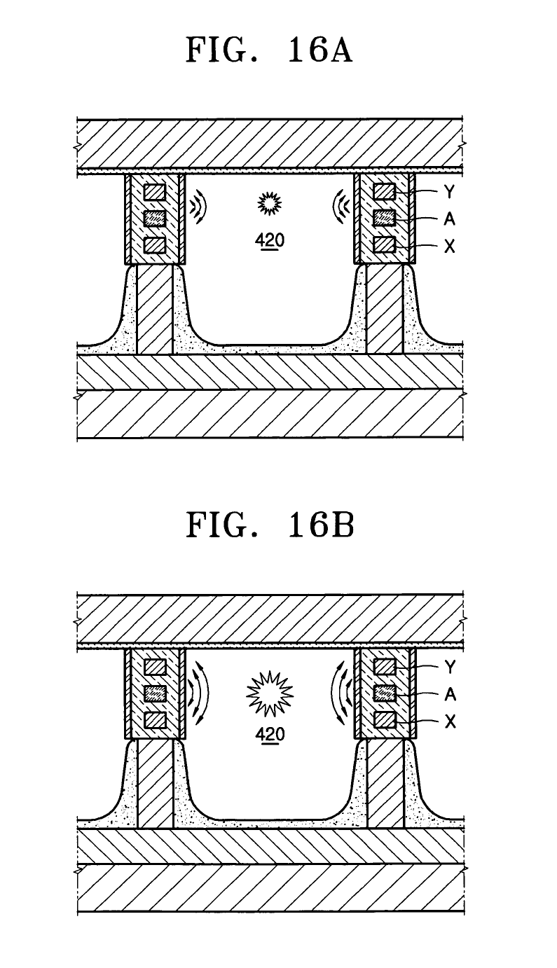

FIGS. 16A and 16B are views of the structure of a PDP where the upper electrodes 407 of FIG. 6 are used as scanning electrodes (Y) and the lower electrodes 406 of FIG. 6 are used as common electrodes (X), according to another embodiment of the present invention.

FIG. 16A is a view for explaining a discharge effected in the low gray-scale group, wherein the sustain-discharge is effected using the address electrodes (A) and the upper scanning electrodes (Y). The driving signal of FIG. 13 is used for the sustain-discharge.

FIG. 16B is a view for explaining a discharge effected in the high gray-scale group, wherein the sustain-discharge is effected using the upper scanning electrodes (Y) and the lower common electrodes (X). The driving signal of FIG. 14 is used for the sustain-discharge.

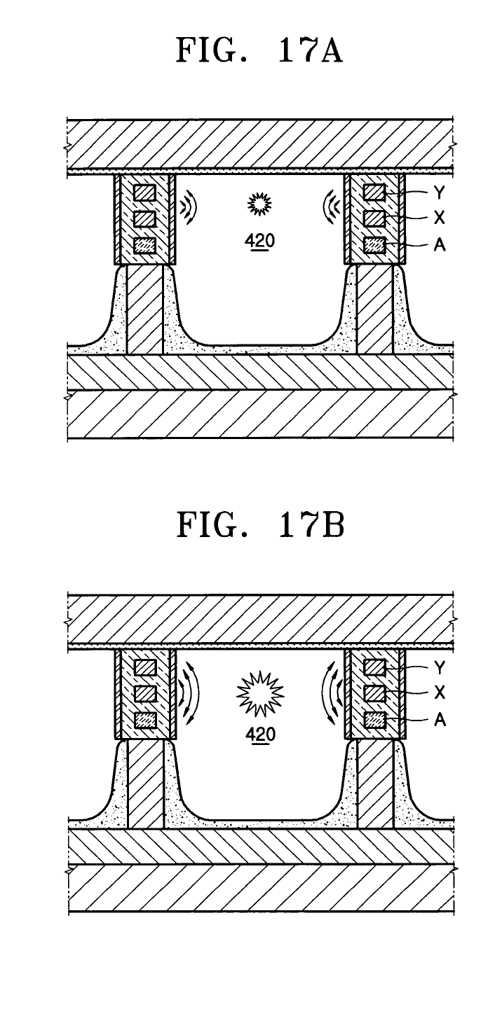

FIGS. 17A and 17B are views of the structure of a PDP where the upper electrodes 407 of FIG. 8 are used as scanning electrodes (Y), the lower electrodes 406 of FIG. 8 are used as common electrodes (X), and the address electrodes 403 of FIG. 8 are arranged between the lower electrodes 406 and the rear substrate 402, according to another embodiment of the present invention.

FIG. 17A is a view for explaining a discharge effected in the low gray-scale group, wherein the sustain-discharge is effected using the upper scanning electrodes (Y) and the lower common electrodes (X). The driving signal of FIG. 14 is used for the sustain discharge.

FIG. 17B is a view for explaining a discharge effected in the high gray-scale group, wherein the sustain-discharge is effected using the upper scanning electrodes (Y) and address electrodes (A). The driving signal of FIG. 13 is used for the sustain discharge.

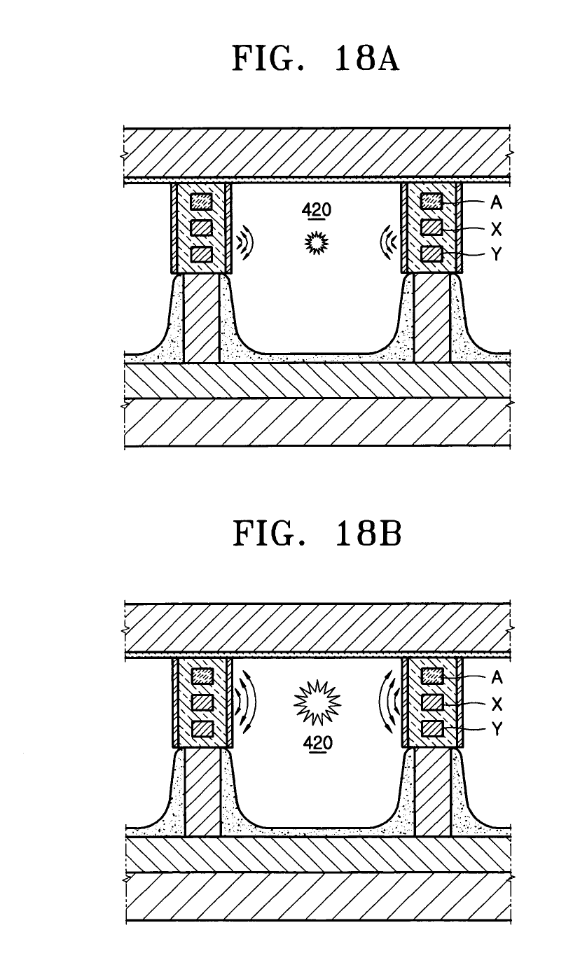

FIGS. 18A and 18B are views of the structure of a PDP where the upper electrodes 407 of FIG. 10 are used as common electrodes (X), the lower electrodes 406 of FIG. 10 are used as scanning electrodes (Y), and the address electrodes 403 of FIG. 10 are arranged between the upper electrodes 407 and the front substrare 401, according to an embodiment of the present invention.

FIG. 18A is a view for explaining a discharge effected in the low gray-scale group, wherein the sustain-discharge is effected using the lower scanning electrodes (Y) and the upper common electrodes (X). The driving signal of FIG. 14 is used for the sustain-discharge.

FIG. 18B is a view for explaining a discharge effected in the high gray-scale group, wherein the sustain-discharge is effected using the lower scanning electrodes (Y) and the address electrodes (A). The driving signal of FIG. 13 is used for the sustain-discharge.

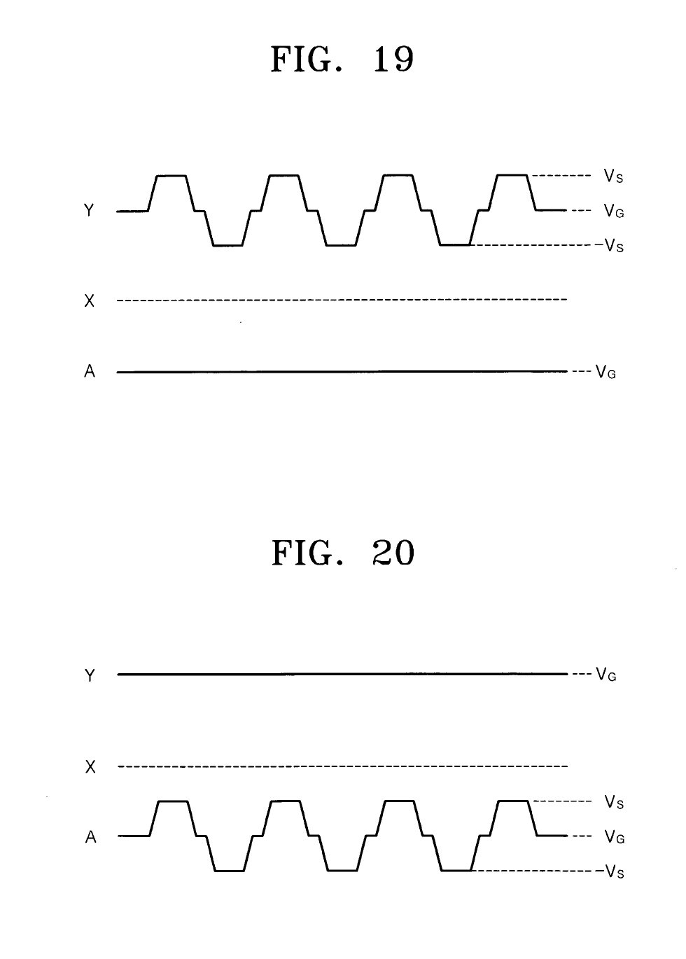

FIG. 19 and FIG. 20 are timing diagrams of a sustain-discharge driving signal supplied to the PDP according to an embodiment of the present invention, wherein the sustain-discharge driving signal is used for the sustain-discharge described above with reference to FIG. 12A. Referring to FIG. 19 and FIG. 20, when the common electrodes (X) are floated, a sustain pulse is supplied to one of the address electrodes (A) and the scanning electrodes (Y). FIG. 19 shows the sustain pulse supplied to the scanning electrodes (Y) alternately having a positive polarity voltage (Vs) and a negative polarity voltage (−Vs), and FIG. 20 shows the sustain pulse supplied to the address electrodes (A) alternately having a positive polarity voltage (Vs) and a negative polarity voltage (−Vs). Because the common electrodes (X) are floated, the sustain discharge is performed between the address electrodes (A) and the scanning electrodes (Y). Also, the driving signal shown in FIG. 19 or FIG. 20 is provided to drive the structures of FIGS. 15A, 16A, 17B, and 18B.

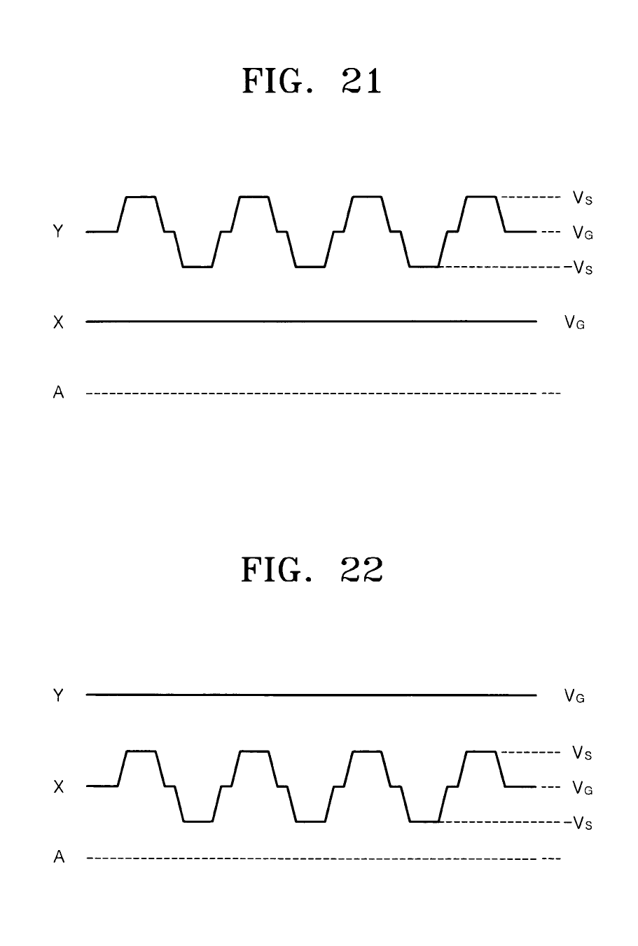

FIG. 21 and FIG. 22 are timing diagrams of a sustain-discharge driving signal supplied to the PDP according to another embodiment of the present invention, wherein the sustain-discharge driving signal is used for sustain-discharge described above with reference to FIG. 12B. Referring to FIG. 21 and FIG. 22, while the address electrodes (A) are floated, a sustain pulse is supplied to one of the scanning electrodes (Y) and the common electrodes (X). FIG. 21 shows the sustain pulse supplied to the scanning electrodes (Y) alternately having a positive polarity voltage (Vs) and a negative polarity voltage (−Vs), and FIG. 22 shows the sustain pulse supplied to the common electrodes (X) alternately having a positive polarity voltage (Vs) and a negative polarity voltage (−Vs). Because the address electrodes (A) are floated, the sustain discharge is performed between the common electrodes (X) and the scanning electrodes (Y). Also, the driving signal shown in FIG. 21 or FIG. 22 is provided to drive the structures shown in FIGS. 15B, 16B, 17A, and 18A.

When driving the PDP according to the present invention, it is possible to classify a plurality of sub-fields into a low gray-scale group and a high gray-scale group and separately drive the two groups.

As discharge spaces increase, the amount of Vacuum Ultra Violet (VUV) light generated increases when discharging. As the generated amount of VUV light increases, the intensity of visible light increases. As a result, as discharge spaces increase, the light-emitting intensity increases. Also, as discharge spaces decrease, the light-emitting intensity decreases.

Considering this principle, in the low gray-scale group, the sustain discharge is effected using relatively narrow discharge spaces between neighboring electrodes, as shown in FIG. 12A. In the high gray-scale group, the sustain discharge is effected using relatively wide discharge spaces between distant electrodes, as shown in FIG. 12B.

As such, by using electrode pairs for the sustain-discharge of the high gray-scale group separate from those for the sustain-discharge of the low gray-scale group, it is possible to more finely represent gray-scale levels.

Various embodiments of panel driving methods that separately drive the low gray-scale group and high gray-scale group are included in FIGS. 15A and 15B.

FIGS. 15A and 15B are views of the structure of a PDP where the lower electrodes 406 of FIG. 6 are used as scanning electrodes (Y) and the upper electrodes 407 of FIG. 6 are used as common electrodes (X), according to an embodiment of the present invention.

FIG. 15A is a view for explaining a discharge effected in the low gray-scale group, wherein the sustain-discharge is effected using the address electrodes (A) and the lower scanning electrodes (Y). The driving signal of FIG. 19 and FIG. 20 is used for the sustain-discharge.

FIG. 15B is a view for explaining discharge effected in the high gray-scale group, wherein the sustain-discharge is effected using the upper common electrodes (X) and the lower scanning electrodes (Y). The driving signal of FIG. 21 and FIG. 22 is used for the sustain-discharge.

FIGS. 16A and 16B are views of the structure of a PDP where the upper electrodes 407 of FIG. 6 are used as scanning electrodes (Y) and the lower electrodes 406 of FIG. 6 are used as common electrodes (X), according to another embodiment of the present invention.

FIG. 16A is a view for explaining a discharge effected in the low gray-scale group, wherein the sustain-discharge is effected using the address electrodes (A) and the upper scanning electrodes (Y). The driving signal of FIG. 19 and FIG. 20 is used for the sustain-discharge.

FIG. 16B is a view for explaining a discharge effected in the high gray-scale group, wherein the sustain-discharge is effected using the upper scanning electrodes (Y) and the lower common electrodes (X). The driving signal of FIG. 21 and FIG. 22 is used for the sustain-discharge.

FIGS. 17A and 17B are views of the structure of a PDP where the upper electrodes 407 of FIG. 8 are used as scanning electrodes (Y), the lower electrodes 406 of FIG. 8 are used as common electrodes (X), and the address electrodes 403 of FIG. 8 are arranged between the lower electrodes 406 and the rear substrate 402, according to another embodiment of the present invention.

FIG. 17A is a view for explaining a discharge effected in the low gray-scale group, wherein the sustain-discharge is effected using the upper scanning electrodes (Y) and the lower common electrodes (X). The driving signal of FIG. 21 and FIG. 22 is used for the sustain discharge.

FIG. 17B is a view for explaining a discharge effected in the high gray-scale group, wherein the sustain-discharge is effected using the upper scanning electrodes (Y) and address electrodes (A). The driving signal of FIG. 19 and FIG. 20 is used for the sustain discharge.

FIGS. 18A and 18B are views of the structure of a PDP where the upper electrodes 407 of FIG. 10 are used as common electrodes (X), the lower electrodes 406 of FIG. 10 are used as scanning electrodes (Y), and the address electrodes 403 of FIG. 10 are arranged between the upper electrodes 407 and the front substrare 401, according to an embodiment of the present invention.

FIG. 18A is a view for explaining a discharge effected in the low gray-scale group, wherein the sustain-discharge is effected using the lower scanning electrodes (Y) and the upper common electrodes (X). The driving signal of FIG. 21 and FIG. 22 is used for the sustain-discharge.

FIG. 18B is a view for explaining a discharge effected in the high gray-scale group, wherein the sustain-discharge is effected using the lower scanning electrodes (Y) and the address electrodes (A). The driving signal of FIG. 19 and FIG. 20 is used for the sustain-discharge.

As described above, the present invention provides the following effects.

In the PDP according to the present invention, visible light is spread to the front substrate through all regions excluding the widths of barrier ribs, without any structural interference of electrodes. Accordingly, the aperture ratio remarkably increases compared with a conventional 3-electrode surface discharge panel. Furthermore, since no electrodes, dielectrics, protection lays, etc. exists in a transmission path of visual light to front substrate, it is possible to remarkably improve transmittance.

Also, in the PDP according to the present invention, a discharge is generated in a ring form from four lateral portions of each light-emitting cell and spreads to the center portion of the light-emitting cell. Accordingly, the spread area of the discharge remarkably increases and, hence, an amount of visual light generated greatly increases. Furthermore, since the plasma is concentrated in the center portion of each light-emitting cell, space charges can be used, which allows low-voltage driving, improves light-emitting efficiency, and accelerates a discharge response speed.

Also, according to the present invention, by using electrode pairs for the sustain-discharge of the high gray-scale group separate from those for the sustain-discharge of the low gray-scale group, it is possible to more finely represent gray-scale levels.

As the discharge spaces increase, the light-emitting intensity increases. As the discharge spaces decrease, the light-emitting intensity decreases.

Considering this principle, according to the present invention, in a low gray-scale group, the sustain-discharge is effected using relatively narrow discharge spaces between adjacent electrodes, and, in a high gray-scale level, the sustain-discharge is effected using relatively wide discharge spaces between distant electrodes. Therefore, according to the present invention, by using electrode pairs for sustain-discharge of the low gray-scale group separate from those for sustain-discharge of the high gray-scale group, it is possible to more finely represent gray-scale levels.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a front substrate;
a rear substrate arranged parallel to the front substrate;
barrier ribs arranged between the front substrate and the rear substrate and adapted to demarcate light-emitting cells in a lattice pattern;
upper electrodes and lower electrodes embedded in the barrier ribs around the light-emitting cells and extending in an arrangement direction of the light-emitting cells arranged in the lattice pattern; and
address electrodes embedded in the barrier ribs around the light-emitting cells and arranged between the upper electrodes and the lower electrodes;
wherein the PDP is driven by a driving signal in which one frame is divided into a plurality of sub-fields according to brightness weights, each sub-field including an address period and a sustain-discharge period; and
during the address period, a scanning signal is supplied to one of the upper electrodes and the lower electrodes, and an address signal is supplied to the address electrodes, to select light-emitting cells to be displayed; and
during the sustain-discharge period, a sustain pulse is supplied to one of the electrodes used for selecting the light-emitting cells in the address period or to one of the upper electrodes and the lower electrodes.

2. The PDP of claim 1, wherein the plurality of sub-fields comprise a low gray-scale group and a high gray-scale group; and
wherein a sustain pulse is supplied to one of the electrodes used for selecting the light-emitting cells in the address period to effect the sustain-discharge period in the low gray-scale group; and
wherein a sustain pulse is supplied to one of the upper electrodes and the lower electrodes in the light-emitting cells selected in the address period to effect the sustain-discharge period in the high gray-scale group.

3. The PDP of claim 2, wherein the other of the electrodes used for selecting the light-emitting cells in the address period to effect the sustain-discharge period are floated in the low gray-scale group; and wherein the other of the upper electrodes and the lower electrodes in the light-emitting cells selected in the address period to effect the sustain-discharge period are floated in the high gray-scale group.

4. The PDP of claim 1, wherein the sustain pulse alternately has a positive polarity voltage and a negative polarity voltage.

5. The PDP of claim 1, wherein the upper electrodes and the lower electrodes extend in a direction with a ladder form surrounding the light-emitting cell, and the address electrodes have a ladder form surrounding the light-emitting cells and extend in a direction orthogonally intersecting the extended direction of the upper electrodes and the lower electrodes.

6. A Plasma Display Panel (PDP), comprising:
a front substrate;
a rear substrate arranged parallel to the front substrate;
barrier ribs arranged between the front substrate and the rear substrate and adapted to demarcate light-emitting cells in a lattice pattern;
upper electrodes and lower electrodes embedded in the barrier ribs around the light-emitting cells and extending in an arrangement direction of the light-emitting cells arranged in the lattice pattern; and
address electrodes embedded in the barrier ribs around the light-emitting cells and arranged between the lower electrodes and the rear substrate;
wherein the PDP is driven by a driving signal in which one frame is divided into a plurality of sub-fields according to brightness weights, each sub-field including an address period and a sustain-discharge period; and
during the address period, a scanning signal is supplied to the upper electrodes and an address signal is supplied to the address electrodes to select light-emitting cells to be displayed; and
during the sustain-discharge period, a sustain pulse is supplied to one of the upper electrodes and the lower electrodes or to one of the upper electrodes and the address electrodes, in the light-emitting cells selected in the address period.

7. The PDP of claim 6, wherein the plurality of sub-fields are classified into a low gray-scale group and a high gray-scale group; and
wherein a sustain pulse is supplied to one of the upper electrodes and the lower electrodes in the light-emitting cells selected in the address period to effect the sustain-discharge period in the low gray-scale group; and
wherein a sustain pulse is supplied to one of the upper electrodes and the address electrodes in the light-emitting cells selected in the address period to effect the sustain-discharge period in the high gray-scale group.

8. The PDP of claim 6, wherein the other of the upper electrodes and the lower electrodes in the light-emitting cells selected in the address period to effect the sustain-discharge period are floated in the low gray-scale group; and wherein the other of the upper electrodes and the address electrodes in the light-emitting cells selected in the address period to effect the sustain-discharge period are floated in the high gray-scale group.

9. The PDP of claim 6, wherein the sustain pulse alternately has a positive polarity voltage and a negative polarity voltage.

10. The PDP of claim 6, wherein the upper electrodes and the lower electrodes extend in a direction with a ladder form surrounding the light-emitting cells, and the address electrodes have a ladder form surrounding the light-emitting cells and extend in a direction orthogonally intersecting the extended direction of the upper electrodes and the lower electrodes.

11. A Plasma Display Panel (PDP), comprising:
a front substrate;
a rear substrate arranged parallel to the front substrate;
barrier ribs arranged between the front substrate and the rear substrate and adapted to demarcate light-emitting cells in a lattice pattern;
upper electrodes and lower electrodes embedded in the barrier ribs around the light-emitting cells and extending in an arrangement direction of the light-emitting cells arranged in the lattice pattern; and
address electrodes embedded in the barrier ribs around the light-emitting cells and arranged between the upper electrodes and the front substrate;
wherein the PDP is driven by a driving signal in which one frame is divided into a plurality of sub-fields according to brightness weights, each sub-field including an address period and a sustain-discharge period; and
wherein a scanning signal is supplied to the lower electrodes and an address signal is supplied to the address electrodes to select light-emitting cells to be displayed during the address period; and
wherein a sustain pulse is supplied to one of the upper electrodes and the lower electrodes or to the lower electrodes and the address electrodes during the sustain-discharge period.

12. The PDP of claim 11, wherein the plurality of sub-fields are classified into a low gray-scale group and a high gray-scale group; and
wherein a sustain pulse is supplied to one of the upper electrodes and the lower electrodes in the light-emitting cells selected in the address period to effect the sustain-discharge period in the low gray-scale group; and
wherein a sustain pulse is supplied to one of the address electrodes and the lower electrodes in the light-emitting cells selected in the address period to effect the sustain-discharge period in the high gray-scale group.

13. The PDP of claim 12, wherein the other of the upper electrodes and the lower electrodes in the light-emitting cells selected in the address period to effect the sustain-discharge period are floated in the low gray-scale group; and the other of the address electrodes and the lower electrodes in the light-emitting cells selected in the address period to effect the sustain-discharge period are floated in the high gray-scale group.

14. The PDP of claim 11, wherein the sustain pulse alternately has a positive polarity voltage and a negative polarity voltage.

15. The PDP of claim 11, wherein the upper electrodes and the lower electrodes are extended in a direction with a ladder form surrounding the light-emitting cells; and
wherein the address electrodes have a ladder form surrounding the light-emitting cells and extend in a direction orthogonally intersecting the extended direction of the upper electrodes and the lower electrodes.
